(19) United States
(12) Patent Application Publication
(10) Pub. No.: US 2024/0004081 A1
(43) Pub. Date: Jan. 4, 2024

(54) DISAMBIGUATION OF CLOSE OBJECTS FROM INTERNAL REFLECTIONS IN ELECTROMAGNETIC SENSORS USING MOTION ACTUATION

(71) Applicant: Waymo LLC, Mountain View, CA (US)

(72) Inventor: Blaise Laurent Patrick Gassend, East Palo Alto, CA (US)

(21) Appl. No.: 17/809,651

(22) Filed: Jun. 29, 2022

(51) Int. Cl. G01S 17/931; G01S 7/481

(52) U.S. Cl. CPC G01S 17/931; G01S 7/4817; B60W 60/001

(57) ABSTRACT

The disclosed aspects and implementations enable efficient disambiguation of spurious internal reflections in sensing (lidar, radar, or sonar) devices from reflections off closely positioned objects by imparting a longitudinal motion to the sensing devices, or components of such devices. In one implementation, the disclosed techniques involve outputting a transmitted wave and receiving a reflected wave generated by the transmitted wave while imparting, to a transceiver, a velocity along a direction of the transmitted wave. The techniques further involve detecting a difference of a transmitted wave frequency and a reflected wave frequency and determining whether the reflected beam is reflected from a real object located in an outside environment or is caused by an internal reflection within the sensing device.

### TECHNICAL FIELD

The instant specification generally relates to range and velocity sensing in applications that involve determining locations and velocities of objects using light detection and ranging (lidar) signals and/or radar detection and ranging (radar) signals reflected from the objects. More specifically, the instant specification is directed to systems and techniques that distinguish reflections from closely positioned objects from artifacts corresponding to internal lidar reflections.

### BACKGROUND

Various automotive, aeronautical, marine, atmospheric, industrial, and other applications that involve tracking locations and motion of objects benefit from optical and radar detection technology. A rangefinder (radar or optical) device operates by emitting a series of signals that travel to an object and then detecting signals reflected back from the object. By determining a time delay between a signal emission and an arrival of the reflected signal, the rangefinder can determine a distance to the object. Additionally, the rangefinder can determine the velocity (the speed and the direction) of the object's motion by emitting two or more signals in a quick succession and detecting a changing position of the object with each additional signal. Coherent rangefinders, which utilize the Doppler effect, can determine a longitudinal (radial) component of the object's velocity by detecting a change in the frequency of the returned wave from the frequency of the emitted signal. When the object is moving away from (or towards) the rangefinder, the frequency of the arrived signal is lower (or higher) than the frequency of the emitted signal, and the change in the frequency is proportional to the radial component of the object's velocity. Autonomous (self-driving) vehicles operate by sensing an outside environment with various electromagnetic (radio, optical, infrared) sensors and charting a driving path through the environment based on the sensed data. Additionally, the driving path can be determined based on positioning (e.g., Global Positioning System (GPS)) and road map data. While the positioning and the road map data can provide information about static aspects of the environment (buildings, street layouts, etc.), dynamic information (such as information about other vehicles, pedestrians, cyclists, etc.) is obtained from contemporaneous electromagnetic sensing data. Precision and safety of the driving path and of the speed regime selected by the autonomous vehicle depend on the quality of the sensing data and on the ability of autonomous driving computing systems to process the sensing data and to provide appropriate instructions to the vehicle controls and the drivetrain.

### BRIEF DESCRIPTION OF THE DRAWINGS

The present disclosure is illustrated by way of examples, and not by way of limitation, and can be more fully understood with references to the following detailed description when considered in connection with the figures, in which:

FIG. 1A is a diagram illustrating components of an example autonomous vehicle (AV) that can deploy a lidar device capable of distinguishing close objects from internal lidar reflections, in accordance with some implementations of the present disclosure.

FIG. 1B is a diagram illustrating an example lidar sensor capable of efficiently distinguishing close objects from spurious internal lidar reflections, in accordance with some implementations of the present disclosure.

FIGS. 2A-B illustrate an example longitudinal actuation of motion of a lidar transceiver using an off-axis positioning of the lidar transceiver on a rotating support platform, in accordance with some implementations of the present disclosure.

FIGS. 3A-D illustrate an example longitudinal actuation of motion of a lidar transceiver using a variable off-axis positioning of the lidar transceiver on a rotating support platform, in accordance with some implementations of the present disclosure.

FIGS. 4A-B illustrate an example longitudinal actuation of motion of a lidar transceiver on a stationary support platform, in accordance with some implementations of the present disclosure. FIG. 4C illustrates the implementation of FIG. 4B in the instance where an object is detected by lidar transceiver that is moving away from the object.

FIG. 5 illustrates example longitudinal actuation of a three-dimensional wide-view lidar transceiver, in accordance with some implementations of the present disclosure.

FIG. 6 illustrates an example method of imparting longitudinal actuation to a lidar or radar device for efficient identification of spurious internal lidar or radar reflections, in accordance with some implementations of the present disclosure.

FIG. 7 depicts a block diagram of an example computer device capable of facilitating a longitudinal actuation of motion of a lidar or radar transmitter and/or receiver for disambiguation of internal return artifacts from reflections by closely positioned objects, in accordance with some implementations of the present disclosure.

### SUMMARY

In one implementation, disclosed is a light detection and ranging (lidar) device that includes a lidar transceiver configured to output a transmitted light beam and to detect a reflected light beam generated by the transmitted light beam. The lidar device further includes a support platform configured to support the lidar transceiver and to impart, to the lidar transceiver, at least a velocity along a direction of the transmitted light beam.

In another implementation, disclosed is a detection and ranging device that includes a transmitter configured to output a transmitted wave, and a receiver configured to detect a reflected electromagnetic wave generated by the transmitted electromagnetic wave. The detection and ranging device further includes a support platform configured to support at least a movable portion of the detection and ranging device. The movable includes at least one of the transmitter or the receiver. The support platform is configured to impart, to the movable portion, a motion along a direction of the transmitted wave.

In another implementation, disclosed is a method that includes outputting, using a lidar transceiver of a lidar device, a transmitted light beam. The method further includes receiving, using the lidar transceiver of the lidar device, a reflected light beam generated by the transmitted light beam. The method further includes imparting, to the lidar transceiver, at least a velocity along a direction of the transmitted light beam. The method further includes detecting a frequency difference between a frequency of the transmitted beam and a frequency of the reflected light beam. The method further includes determining, using the frequency difference, whether the reflected light beam is generated upon interaction of the transmitted light beam with a target located in an outside environment or is caused by an internal reflection within the lidar device.

### DETAILED DESCRIPTION

An autonomous vehicle (AV) or a driver-operated vehicle that uses various driver-assistance technologies can employ lidar technology to detect distances to various objects in the environment and, sometimes, the velocities of such objects. A lidar emits one or more laser signals (pulses) that travel to an object and then detects incoming signals reflected from the object. By determining a time delay between the signal emission and the arrival of the reflected waves, a time-of-flight (ToF) lidar can determine the distance to the object. A typical lidar emits signals in multiple directions to obtain a wide view of the driving environment of the AV. The outside environment can be any environment including any urban environment (e.g., street, etc.), rural environment, highway environment, indoor environment (e.g., the environment of an industrial plant, a shipping warehouse, a hazardous area of a building, etc.), marine environment, and so on. The outside environment can include multiple stationary objects (roadways, buildings, bridges, road signs, shoreline, rocks, trees, etc.), multiple movable objects (e.g., vehicles, bicyclists, pedestrians, animals, ships, boats, etc.), and/or any other objects located outside the AV. For example, a lidar device can cover (e.g., scan) an entire 360-degree view by collecting a series of consecutive frames identified with timestamps. As a result, each sector in space is sensed in time increments that are determined by the angular velocity of the lidar's scanning speed. Sometimes, an entire 360-degree view of the outside environment can be obtained over a scan of the lidar. Alternatively, any smaller sector, e.g., a 1-degree sector, a 5-degree sector, a 10-degree sector, or any other sector can be scanned, as desired.

ToF lidars can also be used to determine velocities of objects in the outside environment, e.g., by detecting two (or more) locations \vec{r}(t₁), \vec{r}(t₂) of some reference point of an object (e.g., the front end of a vehicle) and inferring the velocity as the ratio, \vec{v}=[\vec{r}(t₂)−\vec{r}(t₁)]/[t₂−t₁]. By design, the measured velocity \vec{v} is not the instantaneous velocity of the object but rather the velocity averaged over the time interval t₂−t₁, as the ToF technology does not allow to ascertain whether the object maintained the same velocity \vec{v} during this time or experienced an acceleration or deceleration (with detection of acceleration/deceleration requiring additional locations \vec{r}(t₃), \vec{r}(t₄) . . . of the object).

Coherent or Doppler lidars operate by detecting, in addition to ToF, a change in the frequency of the reflected signal—the Doppler shift—indicative of the velocity of the reflecting surface. Measurements of the Doppler shift can be used to determine, based on a single sensing frame, radial components (along the line of beam propagation) of the velocities of various reflecting points belonging to one or more objects in the outside environment. A signal emitted by a coherent lidar can be modulated (in frequency and/or phase) with a radio frequency (RF) signal prior to being transmitted to a target. A local oscillator copy of the transmitted signal can be maintained on the lidar and mixed with a signal reflected from the target; a beating pattern between the two signals can be extracted and Fourier-analyzed to determine the Doppler frequency shift of f_{D} and signal travel time r to and from the target. The (radial) velocity V of the target relative to the lidar and the distance L to the target can then be determined as,

$$\\ V = \frac{{cf}_{D}}{2 f} , L = \frac{c τ}{2} ,$$

where c is the speed of light and f is the optical frequency of the transmitted signal. More specifically, coherent lidars can determine the velocity of the target and the distance to the target by correlating phase information ϕ_{R}(t) carried by the reflected signal with phase modulation Δ_{LO}(t−τ) of the time-delayed local oscillator (LO) copy of the transmitted signal. The correlations can be analyzed in the Fourier domain with a peak of the correlation function identifying the time of flight τ. Accuracy of resolution of small times of flight τ, associated with closely-positioned objects, is typically insufficient to distinguish objects that are located close to a vehicle, e.g., at distances of the order 1 m, from internal reflections that occur inside the lidar's optical system, e.g., reflections from optical circulators, beam splitters, amplifiers, and other optical elements. Internal reflections incur no Doppler shift and look similar to reflections from close stationary objects.

Aspects and implementations of the present disclosure enable methods and systems that distinguish internal lidar reflections from reflections from close objects. Various described systems can impart longitudinal (in the direction that is parallel or antiparallel to the transmitted beam) velocity to a lidar transmitter and/or receiver and cause reflections from close objects to have a nonzero Doppler shift. This distinguishes close object reflections from internal reflections that have zero Doppler shifts. Imparting longitudinal velocity can be performed using a variety of systems and techniques. In one implementation of a lidar transceiver rotating with angular velocity Ω, the lidar transceiver can be positioned at an offset a relative to the axis of rotation of a support platform with the light beam transmitted along the tangential direction. As a result, the beam reflected from a stationary target will have Doppler shift f_{D}=±2Ωaf/c, the sign depending on whether the velocity of rotation is parallel to the direction of the transmitted beam (+ sign) or antiparallel to the direction of the transmitted beam (− sign). In some implementations, to further distinguish internal reflections from close objects moving with velocity V=±±Ωa, the lidar transceiver can additionally be moved across (or together with) the support platform. For example, the lidar transceiver can oscillate from a first position where the velocity of the lidar transceiver is parallel to the direction of the transmitted beam to a second position where the velocity of the lidar transceiver is antiparallel to the direction of the transmitted beam. This causes the Doppler shift of an object moving with velocity V=Ωa to oscillate (synchronously with the motion of the transceiver) from f_{D}=0 to f_{D}=4Ωaf/c, whereas an internal reflection would result in a steady zero Doppler shift.

In some implementations, in which a lidar transceiver is not rotated and maintains a steady field of view, the support platform can cause an oscillatory motion to the lidar transceiver, e.g., a forward-backward motion that imparts, to the lidar transceiver, a longitudinal velocity along the direction of the transmitted beam. In some implementations, where a lidar is a scanning lidar with the transmitted beam covering a wide (e.g., fish-eye) field of view, the support platform can impart to the transceiver a combination of a forward-backward oscillatory motion and a left-right oscillatory motion. As described in more detail below, such a combined motion improves resolution of close objects located at large angles to the forward direction. In some implementations, where the lidar sensor covers a portion of a three-dimensional environment (e.g., a hemisphere), the support platform can impart an additional up-down oscillatory motion to the transceiver. The advantages of the disclosed implementations include, but are not limited to, efficient identification of close objects that could otherwise be confused with internal reflections from the components of the lidar (or radar) sensor. In turn, such an enhanced functionality of the lidar-based (and/or radar-based) perception systems improves safety of lidar-based (or radar-based) applications, including autonomous vehicles and other applications.

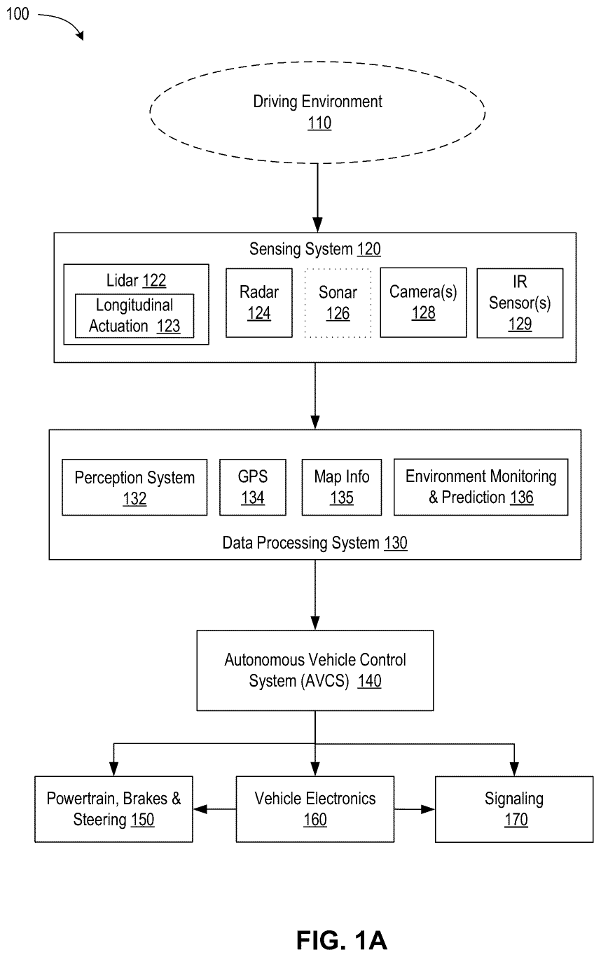

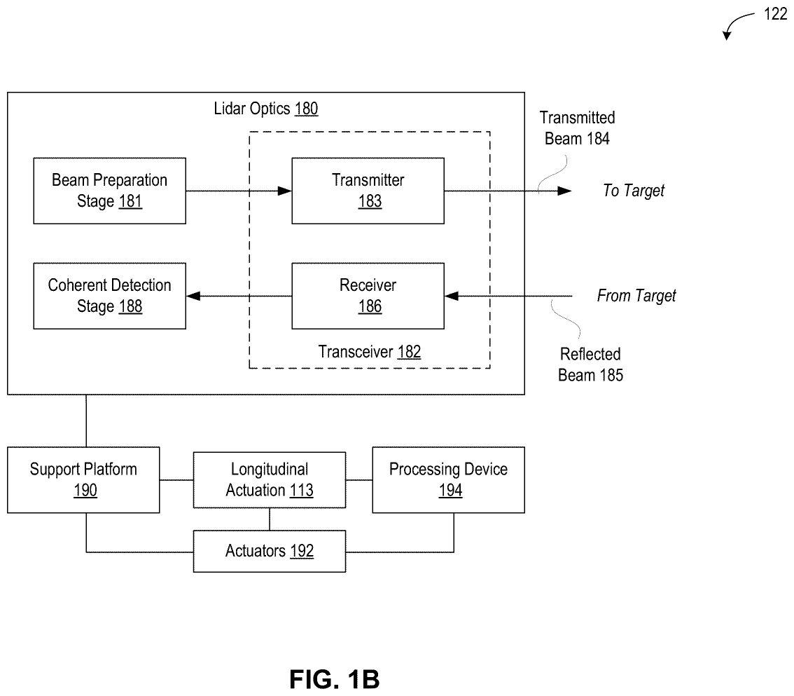

FIG. 1A is a diagram illustrating components of an example autonomous vehicle (AV) 100 that can deploy a lidar device capable of distinguishing close objects from internal lidar reflections, in accordance with some implementations of the present disclosure. Autonomous vehicles can include motor vehicles (cars, trucks, buses, motorcycles, all-terrain vehicles, recreational vehicle, any specialized farming or construction vehicles, and the like), aircraft (planes, helicopters, drones, and the like), naval vehicles (ships, boats, yachts, submarines, and the like), or any other self-propelled vehicles (e.g., robots, factory or warehouse robotic vehicles, sidewalk delivery robotic vehicles, etc.) capable of being operated in a self-driving mode (without a human input or with a reduced human input).

Vehicles, such as those described herein, may be configured to operate in one or more different driving modes. For instance, in a manual driving mode, a driver may directly control acceleration, deceleration, and steering via inputs such as an accelerator pedal, a brake pedal, a steering wheel, etc. A vehicle may also operate in one or more autonomous driving modes including, for example, a semi or partially autonomous driving mode in which a person exercises some amount of direct or remote control over driving operations, or a fully autonomous driving mode in which the vehicle handles the driving operations without direct or remote control by a person. These vehicles may be known by different names including, for example, autonomously driven vehicles, self-driving vehicles, and so on.

As described herein, in a semi or partially autonomous driving mode, even though the vehicle assists with one or more driving operations (e.g., steering, braking and/or accelerating to perform lane centering, adaptive cruise control, advanced driver assistance systems (ADAS), or emergency braking), the human driver is expected to be situationally aware of the vehicle's surroundings and supervise the assisted driving operations. Here, even though the vehicle may perform all driving tasks in certain situations, the human driver is expected to be responsible for taking control as needed.

Although, for brevity and conciseness, various systems and methods are described below in conjunction with autonomous vehicles, similar techniques can be used in various driver assistance systems that do not rise to the level of fully autonomous driving systems. In the United States, the Society of Automotive Engineers (SAE) have defined different levels of automated driving operations to indicate how much, or how little, a vehicle controls the driving, although different organizations, in the United States or in other countries, may categorize the levels differently. More specifically, disclosed systems and methods can be used in SAE Level 2 driver assistance systems that implement steering, braking, acceleration, lane centering, adaptive cruise control, etc., as well as other driver support. The disclosed systems and methods can be used in SAE Level 3 driving assistance systems capable of autonomous driving under limited (e.g., highway) conditions. Likewise, the disclosed systems and methods can be used in vehicles that use SAE Level 4 self-driving systems that operate autonomously under most regular driving situations and require only occasional attention of the human operator. In all such driving assistance systems, accurate lane estimation can be performed automatically without a driver input or control (e.g., while the vehicle is in motion) and result in improved reliability of vehicle positioning and navigation and the overall safety of autonomous, semi-autonomous, and other driver assistance systems. As previously noted, in addition to the way in which SAE categorizes levels of automated driving operations, other organizations, in the United States or in other countries, may categorize levels of automated driving operations differently. Without limitation, the disclosed systems and methods herein can be used in driving assistance systems defined by these other organizations' levels of automated driving operations.

A driving environment 110 can be or include any portion of the outside environment containing objects that can determine or affect how driving of the AV occurs. More specifically, a driving environment 110 can include any objects (moving or stationary) located outside the AV, such as roadways, buildings, trees, bushes, sidewalks, bridges, mountains, other vehicles, pedestrians, bicyclists, and so on. The driving environment 110 can be urban, suburban, rural, and so on. In some implementations, the driving environment 110 can be an off-road environment (e.g. farming or agricultural land). In some implementations, the driving environment can be an indoor environment, e.g., the environment of an industrial plant, a shipping warehouse, a hazardous area of a building, and so on. In some implementations, the driving environment 101 can be substantially flat, with various objects moving parallel to a surface (e.g., parallel to the surface of Earth). In other implementations, the driving environment can be three-dimensional and can include objects that are capable of moving along all three directions (e.g., balloons, falling leaves, etc.). Hereinafter, the term “driving environment” should be understood to include all environments in which an autonomous motion (e.g., SAE Level 5 and SAE Level 4 systems), conditional autonomous motion (e.g., SAE Level 3 systems), and/or motion of vehicles equipped with driver assistance technology (e.g., SAE Level 2 systems) can occur. Additionally, “driving environment” can include any possible flying environment of an aircraft (or spacecraft) or a marine environment of a naval vessel. The objects of the driving environment 101 can be located at any distance from the AV, from close distances of several feet (or less) to several miles (or more).

The example AV 100 can include a sensing system 120. The sensing system 120 can include various electromagnetic (e.g., optical) and non-electromagnetic (e.g., acoustic) sensing subsystems and/or devices. The terms “optical” and “light,” as referenced throughout this disclosure, are to be understood to encompass any electromagnetic radiation (waves) that can be used in object sensing to facilitate autonomous driving, e.g., distance sensing, velocity sensing, acceleration sensing, rotational motion sensing, and so on. For example, “optical” sensing can utilize a range of light visible to a human eye (e.g., the 380 to 700 nm wavelength range), the UV range (below 380 nm), the infrared range (above 700 nm), the radio frequency range (above 1 m), etc. In implementations, “optical” and “light” can include any other suitable range of the electromagnetic spectrum.

The sensing system 120 can include a radar unit 124, which can be any system that utilizes radio or microwave frequency signals to sense objects within the driving environment 110 of the AV 100. Radar unit 124 may deploy a sensing technology that is similar to the lidar technology but uses a radio wave spectrum of the electromagnetic waves. For example, radar unit 124 may use 10-100 GHz carrier radio frequencies. Radar unit 124 may be a pulsed ToF radar, which detects a distance to the objects from the time of signal propagation, or a continuously-operated coherent radar, which detects both the distance to the objects as well as the velocities of the objects, by determining a phase difference between transmitted and reflected radio signals. Compared with lidars, radar sensing units have lower spatial resolution (by virtue of a much longer wavelength), but lack expensive optical elements, are easier to maintain, have a longer working range, and are less sensitive to adverse weather conditions. An AV may often be outfitted with multiple radar transmitters and receivers as part of the radar unit 124. The radar unit 124 can be configured to sense both the spatial locations of the objects (including their spatial dimensions) and their velocities (e.g., using the radar Doppler shift technology). The sensing system 120 can include a lidar sensor 122 (e.g., a lidar rangefinder), which can be a laser-based unit capable of determining distances to the objects in the driving environment 110 as well as, in some implementations, velocities of such objects. The lidar sensor 122 can utilize wavelengths of electromagnetic waves that are shorter than the wavelength of the radio waves and can thus provide a higher spatial resolution and sensitivity compared with the radar unit 124. The lidar sensor 122 can include a ToF lidar and/or a coherent lidar sensor, such as a frequency-modulated continuous-wave (FMCW) lidar sensor, phase-modulated lidar sensor, amplitude-modulated lidar sensor, and the like. Coherent lidar sensors can use optical heterodyne detection for velocity determination. In some implementations, multiple lidar sensor units can be mounted on an AV, e.g., at different locations separated in space, to provide additional information about a transverse component of the velocity of the reflecting object.

Lidar sensor 122 can include one or more laser sources producing and emitting signals and one or more detectors of the signals reflected back from the objects. Lidar sensor 122 can include spectral filters to filter out spurious electromagnetic waves having wavelengths (frequencies) that are different from the wavelengths (frequencies) of the emitted signals. In some implementations, lidar sensor 122 can include directional filters (e.g., apertures, diffraction gratings, and so on) to filter out electromagnetic waves that can arrive at the detectors along directions different from the reflection directions for the emitted signals. Lidar sensor 122 can use various other optical components (lenses, mirrors, gratings, optical films, interferometers, spectrometers, local oscillators, and the like) to enhance sensing capabilities of the sensors.

In some implementations, lidar sensor 122 can include one or more 360-degree scanning units (which scan the outside environment in a horizontal direction, in one example). In some implementations, lidar sensor 122 can be capable of spatial scanning along both the horizontal and vertical directions. The field of view of the lidar sensor 122 can be up to 30 degrees in the vertical directions, 45 degrees in the vertical direction, or any other suitable value. In some implementations, the field of view can be at least 90 degrees in the vertical direction (e.g., with at least a part of the region above the horizon scanned by the lidar signals or with at least part of the region below the horizon scanned by the lidar signals). In some implementations (e.g., in aeronautical environments), the field of view can be a full sphere (consisting of two hemispheres). For brevity and conciseness, when a reference to “lidar technology,” “lidar sensing,” “lidar data,” and “lidar,” in general, is made in the present disclosure, such reference shall be understood also to encompass other sensing technology that operate, generally, at the near-infrared wavelength, but can include sensing technology that operate at other wavelengths as well.

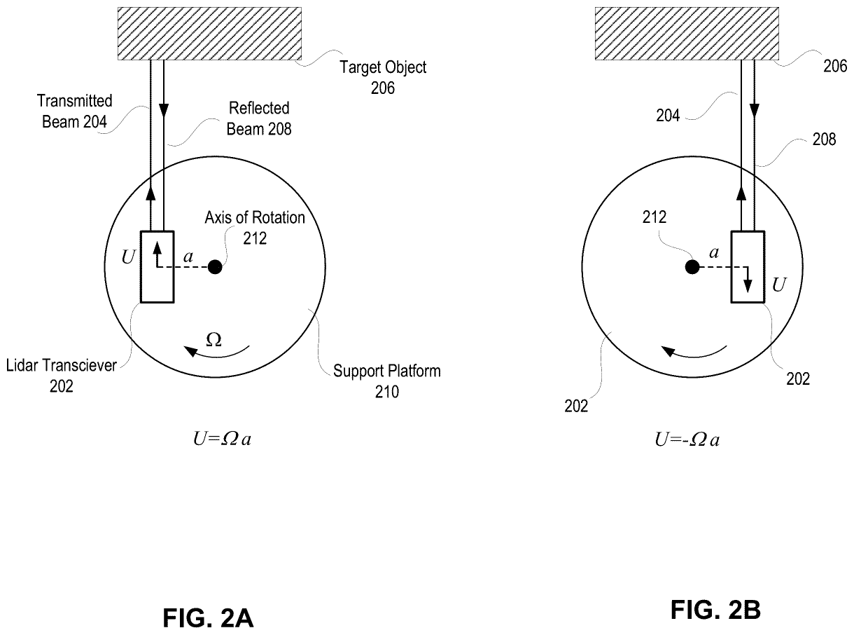

Lidar sensor 122 can include longitudinal actuation 123, which can include a combination of hardware elements and, in some implementations, software components capable of imparting longitudinal motion to the lidar transceiver, via appropriately designed rotations, oscillations, or a combination thereof, as described in more detail below in conjunction with FIGS. 2-5. For example, longitudinal actuation 123 can include any permanent or detachable affixation of the lidar transmitter to a rotating support platform at an off-axis location. Longitudinal actuation 123 can further include actuators that cause the support platform to rotate with a fixed or adjustable angular velocity. In another example, longitudinal actuation 123 can include, as part of the support platform, actuators that cause the lidar transmitter to oscillate along at least a longitudinal direction, but can also impart a designed pattern of motion within both the longitudinal direction and one or both transverse directions.

It should be understood that various implementations described herein (for the sake of concreteness) in relation to lidar devices can similarly be used to impart actuation in radar devices to disambiguate internal radar returns from radar reflections from close objects.

The sensing system 120 can further include one or more cameras 128 to capture images of the driving environment 110. Cameras 128 can operate in the visible part of the electromagnetic spectrum, e.g., 300-800 nm range of wavelengths (herein also referred for brevity as the optical range). Some of the optical range cameras 128 can use a global shutter while other cameras 128 can use a rolling shutter. The images can be two-dimensional projections of the driving environment 110 (or parts of the driving environment 110) onto a projecting surface (flat or non-flat) of the camera(s). Some of the cameras 128 of the sensing system 120 can be video cameras configured to capture a continuous (or quasi-continuous) stream of images of the driving environment 110. The sensing system 120 can also include one or more sonars 126, for active sound probing of the driving environment 110, e.g., ultrasonic sonars, and one or more microphones for passive listening to the sounds of the driving environment 110. The sensing system 120 can also include one or more infrared range cameras 129 also referred herein as JR cameras 129. IR camera(s) 129 can use focusing optics (e.g., made of germanium-based materials, silicon-based materials, etc.) that is configured to operate in the range of wavelengths from microns to tens of microns or beyond. IR camera(s) 129 can include a phased array of IR detector elements. Pixels of IR images produced by camera(s) 129 can be representative of the total amount of IR radiation collected by a respective detector element (associated with the pixel), of the temperature of a physical object whose IR radiation is being collected by the respective detector element, or any other suitable physical quantity.

The sensing data obtained by the sensing system 120 can be processed by a data processing system 130 of AV 100. In some implementations, the data processing system 130 can include a perception system 132. Perception system 132 can be configured to detect and track objects in the driving environment 110 and to recognize/identify the detected objects. For example, the perception system 132 can analyze images captured by the cameras 129 and can be capable of detecting traffic light signals, road signs, roadway layouts (e.g., boundaries of traffic lanes, topologies of intersections, designations of parking places, and so on), presence of obstacles, and the like. The perception system 132 can further receive the lidar sensing data (Doppler data and/or ToF data) to determine distances to various objects in the driving environment 110 and velocities (radial and transverse) of such objects. In some implementations, the perception system 132 can also receive the radar sensing data, which may similarly include distances to various objects as well as velocities of those objects. Radar data can be complementary to lidar data, e.g., whereas lidar data may high-resolution data for low and mid-range distances (e.g., up to several hundred meters), radar data may include lower-resolution data collected from longer distances (e.g., up to several kilometers or more). In some implementations, perception system 132 can use the lidar data and/or radar data in combination with the data captured by the camera(s) 129. In one example, the camera(s) 129 can detect an image of road debris partially obstructing a traffic lane. Using the data from the camera(s) 129, perception system 132 can be capable of determining the angular extent of the debris. Using the lidar data, the perception system 132 can determine the distance from the debris to the AV and, therefore, by combining the distance information with the angular size of the debris, the perception system 132 can determine the linear dimensions of the debris as well.

In another implementation, using the lidar data, the perception system 132 can determine how far a detected object is from the AV and can further determine the component of the object's velocity along the direction of the AV's motion. Furthermore, using a series of quick images obtained by the camera, the perception system 132 can also determine the lateral velocity of the detected object in a direction perpendicular to the direction of the AV's motion. In some implementations, the lateral velocity can be determined from the lidar data alone, for example, by recognizing an edge of the object (using horizontal scanning) and further determining how quickly the edge of the object is moving in the lateral direction. The perception system 132 can receive one or more sensor data frames from the sensing system 120. Each of the sensor frames can include multiple points. Each point can correspond to a reflecting surface from which a signal emitted by the sensing system 120 (e.g., lidar sensor 122) is reflected. The type and/or nature of the reflecting surface can be unknown. Each point can be associated with various data, such as a timestamp of the frame, coordinates of the reflecting surface, radial velocity of the reflecting surface, intensity of the reflected signal, and so on.

The perception system 132 can further receive information from a positioning subsystem, which can include a GPS transceiver (not shown), configured to obtain information about the position of the AV relative to Earth and its surroundings. The positioning data processing module 134 can use the positioning data (e.g., GPS and IMU data) in conjunction with the sensing data to help accurately determine the location of the AV with respect to fixed objects of the driving environment 110 (e.g. roadways, lane boundaries, intersections, sidewalks, crosswalks, road signs, curbs, surrounding buildings, etc.) whose locations can be provided by map information 135. In some implementations, the data processing system 130 can receive non-electromagnetic data, such as audio data (e.g., ultrasonic sensor data, or data from a mic picking up emergency vehicle sirens), temperature sensor data, humidity sensor data, pressure sensor data, meteorological data (e.g., wind speed and direction, precipitation data), and the like.

The data processing system 130 can further include an environment monitoring and prediction component 136, which can monitor how the driving environment 110 evolves with time, e.g., by keeping track of the locations and velocities of the moving objects (e.g., relative to Earth). In some implementations, the environment monitoring and prediction component 136 can keep track of the changing appearance of the environment due to a motion of the AV relative to the environment. In some implementations, the environment monitoring and prediction component 136 can make predictions about how various moving objects of the driving environment 110 will be positioned within a prediction time horizon. The predictions can be based on the current state of the moving objects, including current locations (coordinates) and velocities of the moving objects. Additionally, the predictions can be based on a history of motion (tracked dynamics) of the moving objects during a certain period of time that precedes the current moment. For example, based on stored data for a first object indicating accelerated motion of the first object during the previous 3-second period of time, the environment monitoring and prediction component 136 can conclude that the first object is resuming its motion from a stop sign or a red traffic light signal. Accordingly, the environment monitoring and prediction component 136 can predict, given the layout of the roadway and presence of other vehicles, where the first object is likely to be within the next 3 or 5 seconds of motion. As another example, based on stored data for a second object indicating decelerated motion of the second object during the previous 2-second period of time, the environment monitoring and prediction component 136 can conclude that the second object is stopping at a stop sign or at a red traffic light signal. Accordingly, the environment monitoring and prediction component 136 can predict where the second object is likely to be within the next 1 or 3 seconds. The environment monitoring and prediction component 136 can perform periodic checks of the accuracy of its predictions and modify the predictions based on new data obtained from the sensing system 120. The environment monitoring and prediction component 136 can track relative motion of the AV and various objects, including closely located objects. For example, when the AV is about to begin motion from a parked position near the side of the roadway, the environment monitoring and prediction component 136 can determine, using the techniques of the present disclosure, that close-distance lidar returns are in fact internal reflections. This indicates that there is no real object located next to the AV and that the AV, can therefore, safely begin its motion.

The data generated by the perception system 132, the GPS data processing module 134, and environment monitoring and prediction component 136 can be used by an autonomous driving system, such as AV control system (AVCS) 140. The AVCS 140 can include one or more algorithms that control how AV 100 is to behave in various driving situations and driving environments. For example, the AVCS 140 can include a navigation system for determining a global driving route to a destination point. The AVCS 140 can also include a driving path selection system for selecting a particular path through the immediate driving environment, which can include selecting a traffic lane, negotiating a traffic congestion, choosing a place to make a U-turn, selecting a trajectory for a parking maneuver, and so on. The AVCS 140 can also include an obstacle avoidance system for safe avoidance of various obstructions (rocks, stalled vehicles, a jaywalking pedestrian, and so on) within the driving environment of the AV. The obstacle avoidance system can be configured to evaluate the size, shape, and trajectories of the obstacles (if obstacles are moving) and select an optimal driving strategy (e.g., braking, steering, accelerating, etc.) for avoiding the obstacles.

Algorithms and modules of AVCS 140 can generate instructions for various systems and components of the vehicle, such as the powertrain, brakes, and steering 150, vehicle electronics 160, signaling 170, and other systems and components not explicitly shown in FIG. 1A. The powertrain, brakes, and steering 150 can include an engine (internal combustion engine, electric engine, and so on), transmission, differentials, axles, wheels, steering mechanism, and other systems. The vehicle electronics 160 can include an on-board computer, engine management, ignition, communication systems, carputers, telematics, in-car entertainment systems, and other systems and components. The signaling 170 can include high and low headlights, stopping lights, turning and backing lights, horns and alarms, inside lighting system, dashboard notification system, passenger notification system, radio and wireless network transmission systems, and so on. Some of the instructions outputted by the AVCS 140 can be delivered directly to the powertrain, brakes, and steering 150 (or signaling 170) whereas other instructions output by the AVCS 140 are first delivered to the vehicle electronics 160, which generate commands to the powertrain and steering 150 and/or signaling 170.

In one example, the AVCS 140 can determine that an obstacle identified by the data processing system 130 is to be avoided by decelerating the vehicle until a safe speed is reached, followed by steering the vehicle around the obstacle. The AVCS 140 can output instructions to the powertrain, brakes, and steering 150 (directly or via the vehicle electronics 160) to 1) reduce, by modifying the throttle settings, a flow of fuel to the engine to decrease the engine rpm, 2) downshift, via an automatic transmission, the drivetrain into a lower gear, 3) engage a brake unit to reduce (while acting in concert with the engine and the transmission) the vehicle's speed until a safe speed is reached, and 4) perform, using a power steering mechanism, a steering maneuver until the obstacle is safely bypassed. Subsequently, the AVCS 140 can output instructions to the powertrain, brakes, and steering 150 to resume the previous speed settings of the vehicle.

FIG. 1B is a diagram illustrating an example lidar sensor 122 capable of efficiently distinguishing close objects from spurious internal lidar reflections, in accordance with some implementations of the present disclosure. Example lidar sensor 122 can include lidar optics 180, which should be broadly understood as encompassing any number of optical elements and devices and any number of electronic elements and devices that, collectively, prepare and output a transmitted beam 184 and receive and process a reflected beam 185 generated upon interaction of the transmitted beam 184 with a target (or with internal components of the lidar sensor 122). A beam preparation stage 181 can include one or more light source that produce one or more beams of light. “Beams” should be understood herein as referring to any signals of electromagnetic radiation, such as beams, wave packets, pulses, sequences of pulses, or other types of signals. The light source(s) can include a broadband laser, a narrow-band laser, a light-emitting diode, a Gunn diode, and the like. The light source(s) can include a semiconductor laser, a gas laser, an ND:YAG laser, or any other type of a laser. In some implementations, the light source can be a fiber laser, which may include an optical fiber made of an active gain medium and doped with any suitable chemical dopants, e.g., rare-earth materials, such as erbium, ytterbium, neodymium, dysprosium, praseodymium, thulium, holmium, or any other suitable materials. The light source(s) can be a continuous wave laser, a single-pulse laser, a repetitively pulsed laser, a mode locked laser, and the like.

In some implementations, light output by the light source(s) can be conditioned (pre-processed) to ensure a narrow-band spectrum, target linewidth, coherence, polarization (e.g., circular or linear), and other optical properties that enable coherent (e.g., Doppler) measurements described below. Beam preparation stage 181 can include filters (e.g., narrow-band filters), resonators (e.g., resonator cavities, crystal resonators, etc.), polarizers, feedback loops, lenses, mirrors, diffraction optical elements, and other optical devices. For example, if the light source(s) is a broadband light source, the output light can be filtered to produce a narrowband beam. In some implementations, in which the light source produces light that has a desired linewidth and coherence, the light can still be additionally filtered, focused, collimated, diffracted, amplified, polarized, etc., to produce one or more beams of a desired spatial profile, spectrum, duration, frequency, polarization, repetition rate, and so on. In some implementations, the light source(s) can produce a narrow-linewidth light with a linewidth below 100 KHz.

Beam preparation stage 181 can include a beam splitter (not shown), which produces a local oscillator (LO) copy of the prepared light beam. The LO copy can be used as a reference beam to which reflected beam 185 can be compared. The beam splitter can be a prism-based beam splitter, a partially-reflecting mirror, a polarizing beam splitter, a beam sampler, a fiber optical coupler (optical fiber adaptor), or any similar beam splitting element (or a combination of two or more beam-splitting elements). The light beam can be delivered to the beam splitter (as well as between any other optical components of lidar optics 180) over air or over any suitable light carriers, such as optical fibers or waveguides.

Beam preparation stage 181 can further include an optical modulator (not shown) to impart optical modulation to the beam prepared by beam preparation stage 181. “Optical modulation” is to be understood herein as referring to any form of angle modulation, such as phase modulation (e.g., any sequence of phase changes Δϕ(t) as a function of time 1 that are added to the phase of the beam), frequency modulation (e.g., any sequence of frequency changes Δf(t) as a function of time t), or any other type of modulation (including a combination of a phase and a frequency modulation) that affects the phase of the wave. Optical modulation is also to be understood herein to include, where applicable, amplitude modulation ΔA(t) as a function of time t. Amplitude modulation can be applied to the beam in combination with angle modulation or separately, without angle modulation.

The optical modulator can include an acousto-optic modulator (AOM), an electro-optic modulator (EOM), a Lithium Niobate modulator, a heat-driven modulator, a Mach-Zender modulator, and the like, or any combination thereof. In some implementations, the optical modulator can include a quadrature amplitude modulator (QAM) or an in-phase/quadrature modulator (IQM). The optical modulator can include multiple AOMs, EOMs, IQMs, one or more beam splitters, phase shifters, combiners, and the like. For example, the optical modulator can split an incoming light beam into two beams, modify a phase of one of the split beams (e.g., by a 90-degree phase shift), and pass each of the two split beams through a separate optical modulator to apply angle modulation to each of the two beams using a target encoding scheme. The two beams can then be combined into a single beam. In some implementations, angle modulation can add phase/frequency shifts that are continuous functions of time. In some implementations, added phase/frequency shifts can have a number of discrete values.

In some implementations, the optical modulator can impart angle modulation to the light beam using one or more radio frequency (RF) circuits, such as RF modulators, RF local oscillators, mixers, amplifiers, filters, digital-to-analog converters (DAC), and the like. Even though, for brevity and conciseness, modulation is referred herein as being performed with RF signals, it should be understood that other frequencies can also be used for angle modulation, including but not limited to Terahertz frequencies, microwave frequencies, and so on. The RF circuits can impart optical modulation in accordance with a programmed modulation scheme. In some implementations, a modulated RF signal can cause the optical modulator to impart, to the light beam, a sequence of frequency up-chirps interspersed with down-chirps. In some implementations, phase/frequency modulation can have a duration between a microsecond and tens of microseconds and can be repeated with a repetition rate ranging from one or several kilohertz to hundreds of kilohertz

Lidar optics 180 can include a transmitter 183 to output transmitted beam to the target. In some implementations, transmitter 183 can include an amplifier (not shown) to amplify the beam prepared by beam preparation stage 181. Transmitter 183 can further include any number of optical circulators, optical interfaces, and other optical elements that direct transmitted beam 184 towards the target. Optical elements can include apertures, lenses, mirrors, collimators, polarizers, waveguides, optical switches, optical phased arrays, and the like, or any such combination of optical elements. A reflected beam can be received by lidar optics 180 via a receiver 186. In some implementations, some of the optical elements (e.g., lenses, mirrors, collimators, optical fibers, waveguides, optical switches, optical phased arrays, beam splitters, and the like) can be shared between transmitter 183 and receiver 186 and ensure that the transmitted beam 184 and the reflected beam 185 follow the same (at least partially) optical path. The transmitter 183 and receiver 186 can be collectively referred as transceiver 182 herein but it should be understood that transmitter 183 and receiver 186 can share only some (and, in some implementations, none) of the optical elements. Receiver 186 can separate reflected beam 185 from transmitted beam 184, e.g., using an optical circulator, which can be a Faraday effect-based device, a birefringent crystal-based device, or any other suitable device, and can direct the separated reflected beam 185 to a coherent detection stage 188. In some implementations, any of the aforementioned optical components are integrated on one or more photonic circuits.

Coherent detection stage 188 can include one or more coherent light analyzers, such as balanced photodetectors, that detect phase information carried by the received beam. A balanced photodetector can have photodiodes connected in series and can generate electrical signals that are proportional to a difference of intensities of the input optical modes (which can also be pre-amplified). A balanced photodetector can include photodiodes that are Si-based, InGaAs-based, Ge-based, Si-on-Ge-based, and the like (including an avalanche photodiode, etc.). In some implementations, balanced photodetectors can be manufactured on a single chip, e.g., using complementary metal-oxide-semiconductor (CMOS) structures, silicon photomultiplier (SiPM) devices, or similar systems. Balanced photodetector(s) can also receive the LO copy of the transmitted light beam.

Coherent detection stage 188 can include an optical hybrid stage (not shown), e.g., a 180-degree hybrid stage capable of detecting an absolute value of a phase difference of the input beams, or a 90-degree hybrid stage capable of detecting both the absolute value and a sign of the phase difference of the input beams. One or more photocurrents generated by the optical hybrid stage and representative of the phase difference of the input beams can be digitized by analog-to-digital circuitry (not shown) and provided to a digital signal processor (DSP, not shown), which can determine the Doppler shift and, therefore, the velocity of the target object, as well as the distance to the object.

Lidar optics 180 can have a housing (not shown) that is supported by a support platform 190. Support platform 190 can maintain transmitter 183 and receiver 186 in a particular relative arrangement. Support platform 190 can further maintain alignment of various additional sensors, such as one or more radars 124, cameras 128, and the like. Support platform 190 can be in contact with actuators 192. Actuators 192 can include motors (e.g., electrical motors), pneumatic actuators, hydraulic pistons, piezoelectric rotors, and the like. Actuators 192 can rotate support platform 190 with any angular velocity, e.g., as set by a processing device 194. Actuators 192 can impart longitudinal actuation 123 to transceiver 182. In some implementations, longitudinal actuation 123 can be imparted by virtue of an off-axis positioning of transceiver 182 on the rotating support platform 190. In some implementations, longitudinal actuation 123 can be imparted in addition to the rotation of support platform 190. In some implementations, longitudinal actuation 123 can be imparted to the entire support platform 190. In other implementations, longitudinal actuation 123 (e.g., oscillations) can be imparted to transceiver 182 relative to support platform 190 (e.g., lateral oscillations relative to rotating support platform 190, as described in more detail below).

FIGS. 2A-B illustrate an example longitudinal actuation of motion of a lidar transceiver using an off-axis positioning of the lidar transceiver on a rotating support platform, in accordance with some implementations of the present disclosure. FIGS. 2A-B depict a lidar transceiver 202 emitting a transmitted beam 204 that interacts with a target object 206. A reflected beam 208 is then detected by lidar transceiver 202. Although, for the ease of illustration, transmitted beam 204 and reflected beam 208 are illustrated as following separate optical paths, it should be understood that the two optical paths can be the same, such that transmitted beam 204 is leaving lidar transceiver 202 though the same optical interface that also receives reflected beam 208. Lidar transceiver 202 can be affixed to a support platform 210 at some distance a from an axis of rotation 212 of the support platform 210 that rotates, around axis of rotation 212 with angular velocity Ω. As a consequence of the off-center positioning of lidar transceiver 202, lidar transceiver 202 acquires tangential (perpendicular to the radius indicated with the dashed line) velocity U.

FIG. 2A depicts a positioning of lidar transceiver 202 that causes velocity U to be parallel to the direction of transmitted beam 204 (and antiparallel to the direction of reflected beam 208), where U=Ωa. For example, if a=1 cm and the frequency of rotation is 10 Hz, then Ω=2π×10 Hz=62.8 rad/sec, and the corresponding velocity is U=0.63 m/sec. Accordingly, in a reference frame of lidar transceiver 202, a stationary target object 206 is moving towards lidar transceiver 202 causing the lidar sensor to detect a positive Doppler shift f_{D}=2Ωaf/c. FIG. 2B depicts a positioning of lidar transceiver 202 that causes velocity U to be antiparallel to the direction of transmitted beam 204 (and parallel to the direction of reflected beam 208). Accordingly, in a reference frame of lidar transceiver 202, a stationary target object 206 is moving away from lidar transceiver 202, causing the lidar sensor to detect a negative Doppler shift f_{D}=−2Ωaf/c. Although the orientation of lidar transceiver 202 relative to support platform 210 is shown in FIGS. 2A-B to be parallel (or antiparallel) to velocity U, this is not a requirement and the direction of transmitted beam 204 can make any suitable angle with velocity U (other than 90 degrees).

The decision to choose one of the configurations of FIGS. 2A-B over another configuration can be informed by application-specific considerations. For example, configuration of FIG. 2A allows to efficiently distinguish internal reflections (zero Doppler shift) from close target objects 206 provided that target objects 206 do not move away from axis of rotation 212 with a velocity that is approximately V≈Ωa (within the accuracy of the velocity sensing by the lidar sensor). Similarly, configuration of FIG. 2B allows to efficiently distinguish internal reflections (zero Doppler shift) from close target objects 206 provided that target objects 206 move towards axis of rotation 212 with velocity V≈≈Ωa. In some applications, objects that move towards the lidar sensor (e.g., towards a vehicle equipped with such a sensor) can be of more concern than objects that move away from the lidar sensor. Additionally, objects that move away from the lidar sensor tend to move to a region where distance resolution of the lidar sensor becomes sufficient to distinguish such objects from internal reflections based on the distance (e.g. time-of-flight) measurements. Accordingly, in some applications, the configuration shown in FIG. 2A may be preferred. In some implementations, resolution of objects that move towards (away) from the lidar sensor with velocity V≈Ωa can be further improved by using angular velocity D that varies with time.

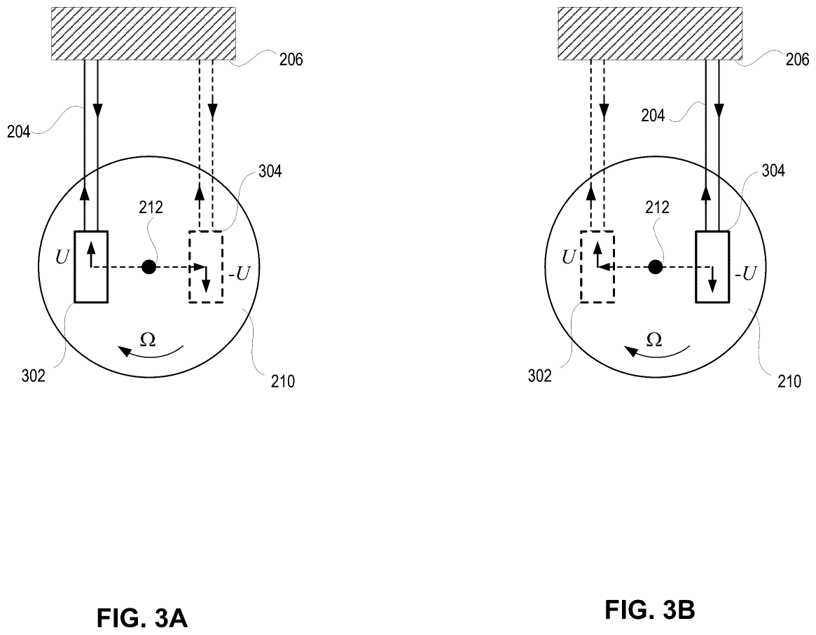

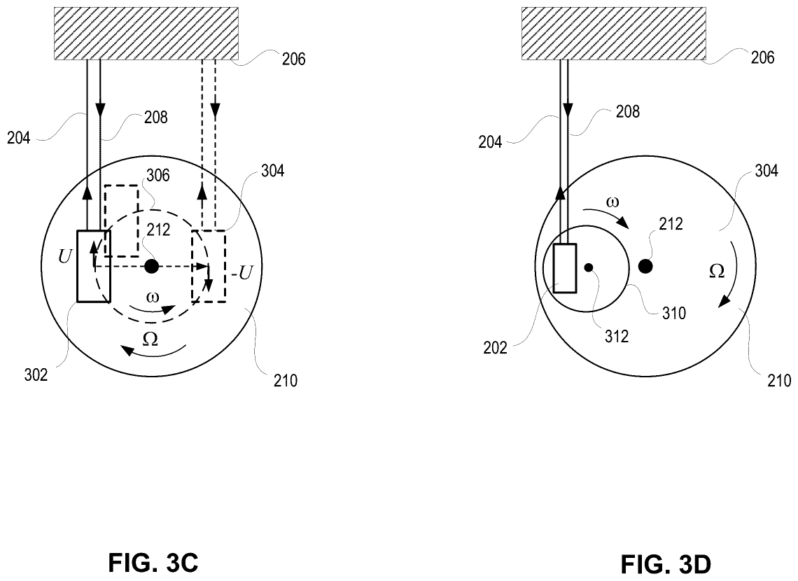

FIGS. 3A-D illustrate an example longitudinal actuation of motion of a lidar transceiver using a variable off-axis positioning of the lidar transceiver on a rotating support platform, in accordance with some implementations of the present disclosure. FIGS. 3A-B illustrate a change in the location of the lidar transceiver (relative to support platform 210) from a first position 302, where the rotational velocity of the transceiver (U) is parallel to transmitted beam 204, to a second position 304, where the rotational velocity of the transceiver (−U) is antiparallel to transmitted beam 204. As depicted with the dashed arrows, the motion of the lidar transceiver relative to support platform 210 can occur along a straight line, e.g., caused by an actuator mounted on support platform 210 (which may be separate from an actuator that causes the rotational motion of support platform 210). In some implementations, motion of the lidar transceiver between the first position 302 and the second position 304 can be a repeated oscillatory motion. In some implementations, angular frequency ω of such oscillatory motion can be different from the angular frequency (velocity) Ω of the rotational motion of support platform 210. In some implementations, the angular frequency (velocity) Ω of the rotational motion can be a multiple of angular frequency ω of the oscillatory motion, e.g., Ω=2ω, 3ω, 4ω . . . . As a result, when Ω=2ω, every odd time the lidar transceiver is facing target object 206, the lidar transceiver is imparted a longitudinal velocity towards target object 206 and every even time the lidar transceiver is imparted the same longitudinal velocity but away from target object 206. A higher ratio of the frequencies, e.g., Ω=4ω, can have the benefit of avoiding a situation where the lidar transceiver accidentally happens to be directly above the axis of rotation 212 every time the lidar transceiver faces target object 206. As a result, a target object that moves with any steady velocity would have a varying Doppler shift whereas an internal reflection would have a zero Doppler shift. In some implementations, the ratio of frequencies is non-integer, e.g., Ω=1.5ω, or any other suitable non-integer value. As a result, each azimuthal direction in space is efficiently probed by the lidar beam within any three consecutive spins of the lidar transceiver rotational motion (meaning that the angle between the direction of the beam and the rotational velocity of the lidar transceiver is within 45 degrees at least once). In some implementations, the ratio of the frequencies can be the Golden ratio, Ω=1.62ω, or approximately the Golden ratio (e.g., 1.6 plus or minus 0.3). FIG. 3C illustrates a change in the location of the lidar transceiver (relative to support platform 210) from the first position 302 to the second position 304 occurring along a trajectory that is different from a straight line, e.g., along a circle 306, an ellipse, or any other suitable path. The direction of motion of the lidar transceiver relative to support platform 210 can be the same as or opposite to (as shown) the direction of rotation of support platform 210 relative to the vehicle or any other object hosting the lidar sensor. More specifically, motion with frequency 12 can occur around axis 212. Motion with frequency ω can occur with the orientation of the lidar being fixed relative to the support platform 212. This latter motion (with an intermediate position 308 shown for illustration) can be viewed as the rotation with frequency ω around axis of rotation 212 superimposed on another rotation occurring with frequency −ω around the axis of the lidar.

FIG. 3D illustrates a two-stage motion of the lidar transceiver. More specifically, a second stage 310, to which lidar transceiver 202 is affixed, can be rotated with frequency ω (or, in some implementations, with frequency −ω) around second axis 312 relative to a first stage (e.g., support platform 210), so that the angle between transmitted beam 204 and the velocity of the rotational motion of the first stage is periodically changed (with frequency ω). Although FIG. 3D shows lidar transceiver 202 positioned at some offset relative to second axis 312, in some implementations lidar transceiver 202 can be located with zero offset, right at the second axis 312.

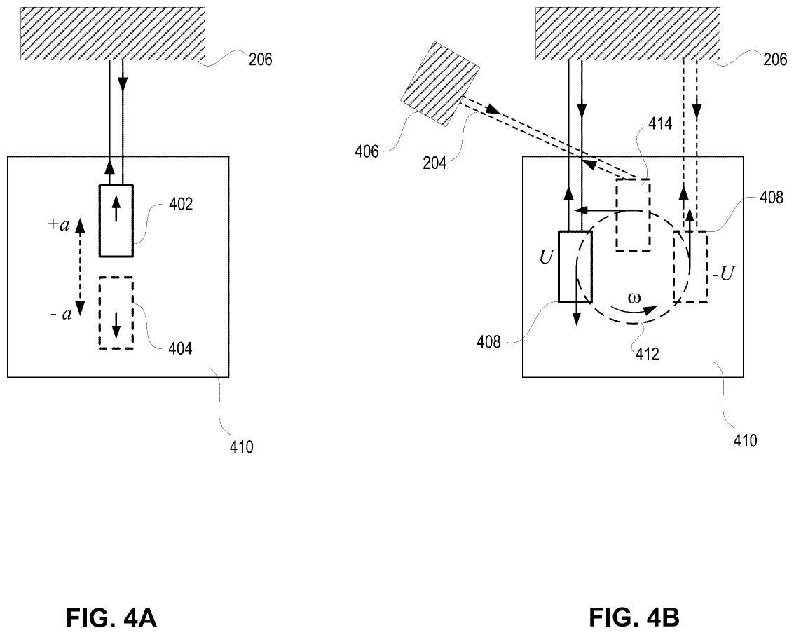

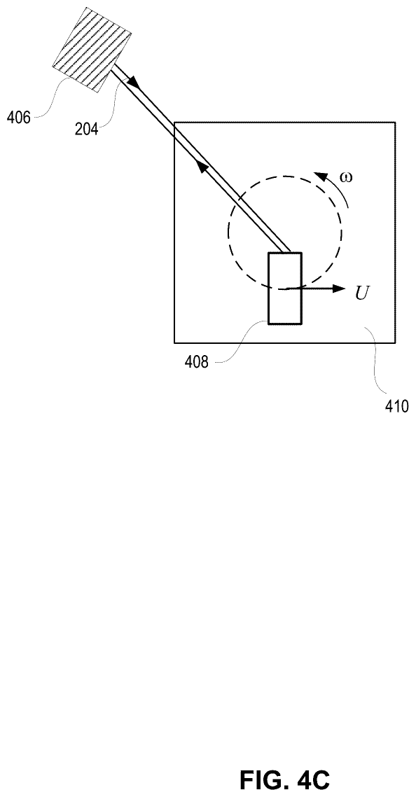

FIGS. 4A-B illustrate an example longitudinal actuation of motion of a lidar transceiver on a stationary support platform, in accordance with some implementations of the present disclosure. FIG. 4A illustrates longitudinal oscillations with amplitude a between a first position 402 and a second position 404 relative to a stationary support platform 410. In some implementations, the oscillations can be described by a longitudinal displacement x=ωt and velocity U=ωt. The oscillations with amplitude a in the interval between 1 mm and 1 cm and frequency ω between 2π×100 Hz and 2π×10 Hz can achieve the same maximum longitudinal velocity U=0.63 m/sec as in the example setup of FIG. 2A. FIG. 4B illustrates a variation of the setup of FIG. 4A in the implementations that deploy lidar sensors with a wide field of view (e.g., in a fan-like or a fish-eye pattern). For transmitted beams 204 that make a large angle with the central direction, e.g., beams used to detect an object 406, the projection of the velocity imparted to the lidar transmitter 408 on the longitudinal direction (along the transmitted beam 204) is significantly decreased. To alleviate the detrimental effect of the large angle of transmission, the trajectory of the center of lidar transmitter 408 relative to support platform 410 can be different from a straight line, e.g., the trajectory can follow a circle 412, an ellipse, or any other similar path. This increases the component of the velocity U along the direction of the transmitted beam 204 for at least some parts of the trajectory (e.g., as illustrated in FIG. 4B with the apex position 414 on the circle 412). FIG. 4C illustrates the implementation of FIG. 4B in the instance where object 406 is detected by lidar transmitter 408 that is moving away from object 406.

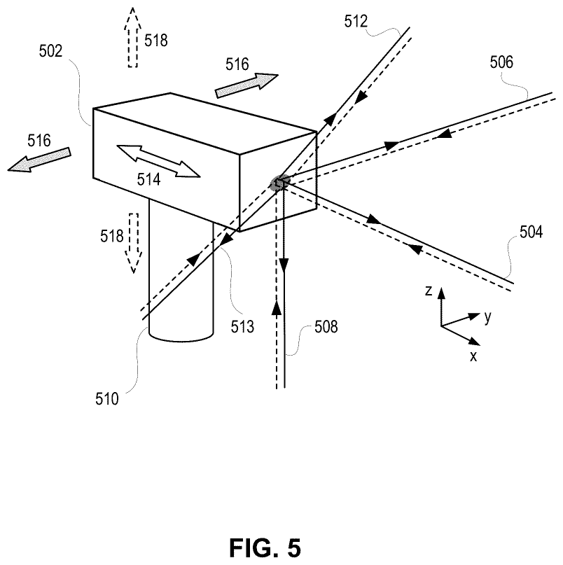

FIG. 5 illustrates example longitudinal actuation of a three-dimensional wide-view lidar transceiver, in accordance with some implementations of the present disclosure. As shown, a lidar transceiver 502 is mounted on a support platform 510 that can include actuators (not shown) imparting oscillations to lidar transceiver 502 in multiple directions. More specifically, to facilitate distinguishing close objects detected by a transmitted beam 504, which follows the direction along the main axis (e.g., x-axis) of lidar transceiver 502, from internal reflections, support platform 510 can impart oscillations 514 (depicted schematically with white arrows). For the transmitted beams that make large angles with the main x-axis, e.g., a transmitted beam 506 that travels close to y-axis or a transmitted beam 508 that travels close to z-axis, oscillations 514 imparted along the x-axis can be less efficient for distinguishing internal reflections. To distinguish internal reflections associated with such beams, support platform 510 can impart oscillations 516 (indicated with shaded arrow) along the y-axis and/or oscillations 518 (indicated with dashed arrows) along the z-axis. In some implementations, oscillations along the three directions can have different amplitudes aₓ, a_{y}, a_{z}, different frequencies ωₓ, ω_{y}, ω_{z}, and different phases ϕₓ, ϕ_{y}, ϕ_{z}, e.g., x(t)=aₓ cos(ωₓt+ϕₓ), y(t)=a_{y} cos(ω_{y}t+ϕ_{y}), z(t)=a_{z} cos(ω_{z}t+ϕ_{z}). In some implementations, all frequencies can be different. In some implementations, two frequencies can be multiples of a third frequency, e.g. ωₓ:ω_{y}:ω_{z}=4ω₀:2ω₀:ω₀, or ωₓ:ω_{y}:ω_{z}=3ω₀:2ω0:ω₀, or some other ratios. In some implementations, e.g., where oscillations along two directions are used, the frequencies can be equal to each other, ωₓ=ω_{y} while the phase shifts the offset by 90 degrees, ϕₓ=ϕ_{y}±π/4. In those implementations where oscillations are induced along all three directions, the third frequency ω_{z} can be different from the other two frequencies, e.g., ω_{z}=1.5ωₓ, or any other suitable value, such as the Golden ratio, e.g., ω_{z}=1.62ωₓ, or approximately the Golden ratio (e.g., 1.6 plus or minus 0.3).

It should be understood that the implementations illustrated in FIGS. 1-5 are intended as examples and do not limit systems and techniques that can implement longitudinal actuation for disambiguation of close objects from internal reflection artifacts. Various additional components of lidar (and/or radar or sonar) devices can be present that have not been specifically depicted in FIGS. 1-5. For example, a lidar (radar or sonar) transmitter and receiver can be enclosed in a housing, e.g., a dome housing, to protect the optical and electronic components from elements of the outside environment. The housing may generate additional internal reflections. To distinguish such reflections from reflections by objects in the outside environment, the additional actuation may be imparted to the housing, in some implementations. For example, in implementations that impart vibrations (oscillations) to the transceiver (e.g., as illustrated in FIGS. 4A-B), the housing can be vibrated in sync with the transceiver. In implementations that impart rotations to the transceiver, the housing can be similarly rotated. In some implementations, the off-axis positioning of the transceiver (e.g., as illustrated in FIGS. 3A-B) within the housing can itself eliminate (or at least reduce substantially) internal reflections from the housing if the transmitted beam is incident at the surface of the housing at non-zero angle so that the light reflected from the housing is not back-reflected along the same optical path.

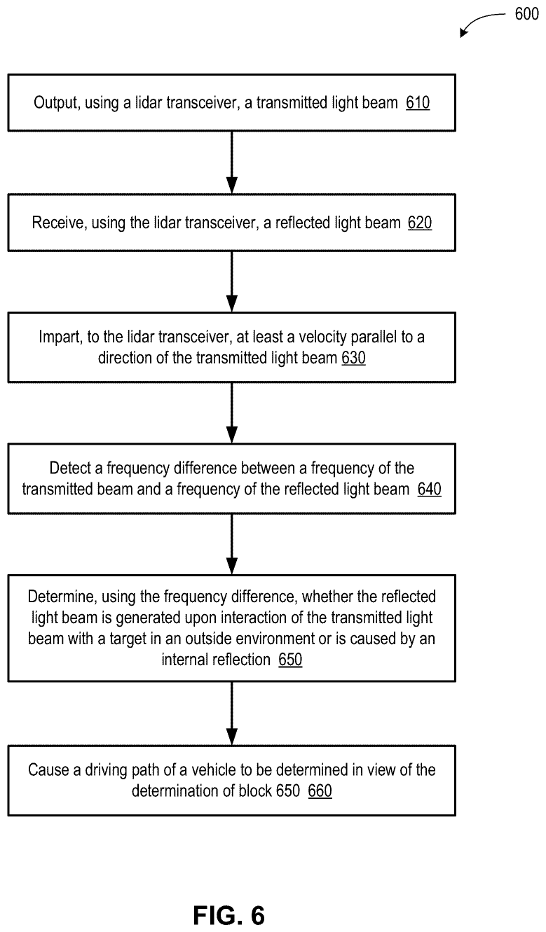

FIG. 6 illustrates an example method 600 of imparting longitudinal actuation to a lidar or radar device for efficient identification of spurious internal lidar or radar reflections, in accordance with some implementations of the present disclosure. Method 600 or any of its individual operations can be performed by a combination of a sensing system 120 of FIG. 1, which includes a lidar (or a radar or sonar) device, and a processing system 120 of FIG. 1. The processing system can include a processing device, having one or more processing units (CPUs) and memory devices communicatively coupled to the CPU(s). In some implementations, method 600 can be directed to systems and components of an autonomous driving vehicle, such as the autonomous vehicle 100 of FIG. 1. Method 600 can be used to improve performance of the processing system 120 and/or the autonomous vehicle control system 140. In certain implementations, a single processing thread can perform at least some operations of method 600. Alternatively, two or more processing threads can perform at least some operations of method 600, each thread executing one or more individual functions, routines, subroutines, or operations of method 600. In an illustrative example, the processing threads implementing method 600 can be synchronized (e.g., using semaphores, critical sections, and/or other thread synchronization mechanisms). Alternatively, the processing threads implementing method 600 can be executed asynchronously with respect to each other. Various operations of method 600 can be performed in a different order compared with the order shown in FIG. 6. Some operations of method 600 can be performed concurrently with other operations. Some operations can be optional.

At block 610, method 600 can include obtaining, using a lidar transceiver of a lidar device (e.g., transceiver 182 in FIG. 1B), a transmitted light beam (e.g., transmitted beam 184). At block 620, method 600 can include receiving, using the lidar transceiver of the lidar device, a reflected light beam (e.g., reflected beam 185) generated by the transmitted light beam. The reflected light beam can be generated upon interaction of the transmitted light beam with a target in an outside environment or upon interaction of the transmitted light beam with various internal parts and components of the lidar device.

At block 630, method 600 can include imparting, to the lidar transceiver, at least a velocity along a direction of the transmitted light beam (e.g., as depicted in FIG. 2A, FIG. 2B, etc.). The term “along” should be understood as including a direction that is parallel to the transmitted light beam as well as a direction that is antiparallel to the transmitted light beam (e.g., the direction that is parallel to a direction of the reflected light beam). It should be understood that imparting a velocity along the direction of the transmitted light beam does not preclude a simultaneous imparting of a transverse velocity, e.g., a velocity along any two directions perpendicular to the transmitted light beam.

Imparting, to the lidar transceiver, the velocity along the direction of the transmitted light beam can be performed using a number of different implementations. In one example, the velocity along the direction of the transmitted light beam may be imparted by rotating a support platform (e.g., support platform 210) around an axis of rotation, e.g., as depicted in FIG. 2A or FIG. 2B. The lidar transceiver (e.g., lidar transceiver 202) can be affixed to the support platform at a location that is offset relative to the axis of rotation (e.g., offset by a radial distance a, as depicted in FIG. 2A or FIG. 2B).

In some implementations, imparting velocity along the direction of the transmitted light beam can include imparting, to the lidar transceiver, a rotational velocity (e.g., velocity U, as indicated in FIG. 2A) that is parallel to the direction of the transmitted light beam, e.g., as depicted in FIG. 2A.

In some implementations, imparting velocity along the direction of the transmitted light beam can include imparting, to the lidar transceiver, a rotational velocity that is antiparallel to the direction of the transmitted light beam, e.g., as depicted in FIG. 2B.

In some implementations, to combine the benefits of parallel and antiparallel rotational velocities imparted to the lidar transceiver, the support platform can be configured to impart, to the lidar transceiver, a rotational motion relative to the support platform (e.g., around a circle 412 depicted in FIG. 4B or any other suitable curve).

In some implementations, the support platform can be configured to impart, to the lidar transceiver, a first oscillatory motion along at least the direction of the transmitted light beam (e.g., as illustrated in FIG. 4A) or an axis of a field of view of the lidar device (e.g., a fish-eye lidar device). In some implementations, the support platform (e.g., support platform 510 in FIG. 5) can be further configured to impart, to the lidar transceiver, a vibrational motion (e.g., oscillations 516 in FIG. 5) along at least a first direction perpendicular to the axis of the field of view of the lidar device (e.g., y-axis in FIG. 5). In some implementations, the support platform can be further configured to impart, to the lidar transceiver, a second oscillatory motion (e.g., oscillations 518 in FIG. 5) along at least a second direction perpendicular to the axis of the field of view of the lidar device (e.g., z-axis in FIG. 5).

At block 640, method 600 can include detecting a frequency difference (e.g., Doppler shift) between a frequency of the transmitted light beam and a frequency of the reflected light beam. Detection of the frequency difference can be performed using any appropriate coherent receiver circuit, including a coherent optical receiver circuit (e.g., coherent detection stage 188). A coherent optical receiver circuit can include photodetectors, optical hybrids, radio frequency circuits, Fourier analyzers, digital signal processing circuits, and any other suitable components.

At block 650, method 600 can include determining, using the detected frequency difference, whether the reflected light beam is generated upon interaction of the transmitted light beam with a target located in an outside environment or is caused by an internal reflection within the lidar device. For example, a non-zero frequency difference can be indicative of a real object in the outside environment whereas a zero frequency difference can be indicative of a spurious internal reflection.

At block 660, method 600 can continue with causing a driving path of a vehicle to be determined in view of determining that the reflected light beam is caused by the internal reflection within the lidar device. A perception system of the vehicle can ignore such spurious internal reflections. On the other hand, if it is determined, at block 650, that the lidar reflection is a real reflection from a closely located object (e.g., a pedestrian standing next to a vehicle), the perception system can prevent the vehicle from moving until the object moves away from the vehicle.

Numerous variations of method 600 are within the scope of this disclosure. Even though the description above, for conciseness, uses a lidar device as an example, any other ranging devices that deploy electromagnetic or acoustic waves for detection of Doppler frequency shifts can be used, e.g., in a radio detection and ranging devices (radars and/or sonars). Additionally, while the description above illustrates imparting rotational and/or vibrational (oscillatory) motion to the transceiver combination that includes both the transmitter and the receiver, in some implementations, motion can be imparted to only one of the transmitter or the receiver of a lidar (or a radar device or a sonar device). In particular, with reference to FIG. 4A, only the transmitter (or receiver) can vibrate between first position 402 and second position 404 while the receiver (or transmitter) can remain stationary relative to support platform 410.

In such implementations, method 600 can be performed by a lidar device that includes a transmitter configured to output a transmitted electromagnetic wave (e.g., a light wave or a radio wave) and a receiver configured to detect a reflected electromagnetic wave generated by the transmitted electromagnetic wave. For example, the reflected electromagnetic wave can be generated upon interaction of the transmitted electromagnetic wave with a target or with internal components of the ranging device. The detection and ranging device can include a support platform configured to support at least a movable portion of the detection and ranging device. The movable portion can include at least one of the transmitter or the receiver. The support platform can be configured to impart, to the movable portion, a motion along a direction of the transmitted electromagnetic wave, e.g., as described above in conjunction with FIGS. 2-5. In some implementations, the motion imparted to the movable portion can include a plurality of first phases and a plurality of second phases. During each of the plurality of first phases, the motion imparted to the movable portion can be parallel to the direction of the transmitted electromagnetic wave (e.g., forward motion to first position 402 in FIG. 4). During each of the plurality of second phases, the motion imparted to the movable portion can be antiparallel to the direction of the transmitted electromagnetic wave (e.g., backward motion to second position 404 in FIG. 4).

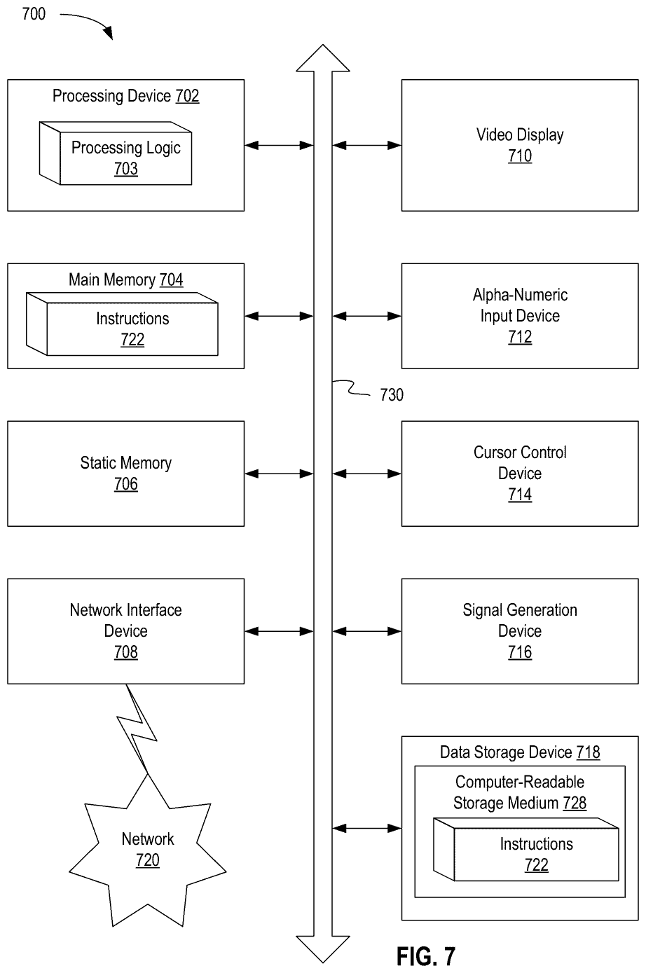

FIG. 7 depicts a block diagram of an example computer device 700 capable of facilitating a longitudinal actuation of motion of a lidar or radar transmitter and/or receiver for disambiguation of internal return artifacts from reflections by closely positioned objects, in accordance with some implementations of the present disclosure. Example computer device 700 can be (or include) processing device 194 of FIG. 1B, and connected to other computer devices in a LAN, an intranet, an extranet, and/or the Internet. Computer device 700 can operate in the capacity of a server in a client-server network environment. Computer device 700 can be a microcontroller, a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 700 can include a processing device 702 (also referred to as a processor or CPU), a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which can communicate with each other via a bus 730.

Processing device 702 (which can include processing logic 703) represents one or more general-purpose processing devices such as a microprocessor, central processing unit, or the like. More particularly, processing device 702 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 can also be one or more special-purpose processing devices such as an application specific integrated circuit (ASIC), a field programmable gate array (FPGA), a digital signal processor (DSP), network processor, or the like. In accordance with one or more aspects of the present disclosure, processing device 702 can be configured to execute instructions performing method 600 of imparting longitudinal actuation to a lidar or radar device for efficient identification of spurious internal lidar or radar reflections.

Example computer device 700 can further comprise a network interface device 708, which can be communicatively coupled to a network 720. Example computer device 700 can further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Data storage device 718 can include a computer-readable storage medium (or, more specifically, a non-transitory computer-readable storage medium) 728 on which is stored one or more sets of executable instructions 722. In accordance with one or more aspects of the present disclosure, executable instructions 722 can comprise executable instructions performing method 600 of imparting longitudinal actuation to a lidar or radar device for efficient identification of spurious internal lidar or radar reflections.

Executable instructions 722 can also reside, completely or at least partially, within main memory 704 and/or within processing device 702 during execution thereof by example computer device 700, main memory 704 and processing device 702 also constituting computer-readable storage media. Executable instructions 722 can further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A light detection and ranging (lidar) device comprising:
a lidar transceiver configured to output a transmitted light beam and to detect a reflected light beam generated by the transmitted light beam; and
a support platform configured to support the lidar transceiver and to impart, to the lidar transceiver, at least a velocity along a direction of the transmitted light beam.

2. The lidar device of claim 1, wherein the support platform is configured to rotate around an axis of rotation.

3. The lidar device of claim 2, wherein the lidar transceiver is affixed to the support platform at a location that is offset relative to the axis of rotation.

4. The lidar device of claim 3, wherein the support platform is configured to impart, to the lidar transceiver, a rotational velocity that is parallel to the direction of the transmitted light beam.

5. The lidar device of claim 2, wherein the support platform is further configured to impart, to the lidar transceiver, an oscillatory motion in at least a direction perpendicular to the transmitted light beam.

6. The lidar device of claim 2, wherein the support platform is further configured to impart, to the lidar transceiver, a rotational motion relative to the support platform.

7. The lidar device of claim 1, wherein the support platform is configured to impart, to the lidar transceiver, a first oscillatory motion along at least an axis of a field of view of the lidar device.

8. The lidar device of claim 7, wherein the support platform is further configured to impart, to the lidar transceiver, a second oscillatory motion along at least a first direction perpendicular to the axis of the field of view of the lidar device.

9. The lidar device of claim 8, wherein the support platform is further configured to impart, to the lidar transceiver, a third oscillatory motion along a second direction perpendicular to the axis of the field of view of the lidar device

10. The lidar device of claim 1, further comprising:
a coherent optical receiver circuit configured to detect a frequency difference between a frequency of the transmitted light beam and a frequency of the reflected light beam; and
a processing device communicatively coupled to the coherent optical receiver circuit, the processing device configured to determine, using the frequency difference, whether the reflected light beam is (i) generated upon interaction of the transmitted light beam with a target located in an outside environment or (ii) caused by an internal reflection of the transmitted light beam within the lidar device.

11. A detection and ranging device comprising:
a transmitter configured to output a transmitted wave;
a receiver configured to detect a reflected electromagnetic wave generated by the transmitted electromagnetic wave; and
a support platform configured to support at least a movable portion of the detection and ranging device, wherein the movable portion comprises at least one of the transmitter or the receiver, and wherein the support platform is configured to impart, to the movable portion, a motion along a direction of the transmitted wave.

12. The detection and ranging device of claim 11, wherein the motion imparted to the movable portion comprises a plurality of first phases and a plurality of second phases, wherein during each of the plurality of first phases the motion imparted to the movable portion is parallel to the direction of the transmitted wave, and wherein during each of the plurality of second phases the motion imparted to the movable portion is antiparallel to the direction of the transmitted wave.

13. The detection and ranging device of claim 11, further comprising:
a coherent receiver circuit configured to detect a frequency difference between a frequency of the transmitted wave and a frequency of the reflected wave; and
a processing device communicatively coupled to the coherent receiver circuit, the processing device configured to determine, using the frequency difference, whether the reflected wave is generated upon interaction of the transmitted electromagnetic wave with a target located in an outside environment or is caused by an internal reflection within the detection and ranging device.

14. A system comprising:
a sensing system of a vehicle, the sensing system comprising a light detection and ranging (lidar) device, the lidar device comprising:
a lidar transceiver configured to output a transmitted light beam and to detect a reflected light beam generated by the transmitted light beam;
a support platform configured to support the lidar transceiver and to impart, to the lidar transceiver, at least a velocity along a direction of the transmitted light beam; and
a coherent optical receiver circuit configured to detect a frequency difference between a frequency of the transmitted beam and a frequency of the reflected light beam; and
a data processing system of the vehicle, the data processing system communicatively coupled to the coherent optical receiver circuit and configured to determine, using the frequency difference, whether the reflected light beam is generated upon interaction of the transmitted light beam with a target located in an outside environment or is caused by an internal reflection within the lidar device.

15. The system of claim 14, wherein the data processing system of the vehicle is further configured to cause a driving path of the vehicle to be determined in view of determining that the reflected light beam is caused by the internal reflection within the lidar device.

16. A method comprising:
outputting, using a lidar transceiver of a lidar device, a transmitted light beam;
receiving, using the lidar transceiver of the lidar device, a reflected light beam generated by the transmitted light beam;
imparting, to the lidar transceiver, at least a velocity along a direction of the transmitted light beam; and
detecting a frequency difference between a frequency of the transmitted beam and a frequency of the reflected light beam; and
determining, using the frequency difference, whether the reflected light beam is generated upon interaction of the transmitted light beam with a target located in an outside environment or is caused by an internal reflection within the lidar device.

17. The method of claim 16, wherein imparting, to the lidar transceiver, the velocity along the direction of the transmitted light beam comprises rotating a support platform around an axis of rotation, and wherein the lidar transceiver is affixed to the support platform at a location that is offset relative to the axis of rotation.

18. The method of claim 16, wherein imparting, to the lidar transceiver, the velocity along the direction of the transmitted light beam comprises imparting, to the lidar transceiver, a rotational velocity that is parallel to the direction of the transmitted light beam.

19. The method of claim 16, wherein imparting, to the lidar transceiver, the velocity along the direction of the transmitted light beam comprises imparting, to the lidar transceiver, an oscillatory motion along at least the direction of the transmitted light beam.

20. The method of claim 16, further comprising:
causing a driving path of a vehicle to be determined in view of determining that the reflected light beam is caused by the internal reflection within the lidar device.
